(19) United States
(12) Patent Application Publication
(10) Pub. No.: US 2019/0163810 A1
(43) Pub. Date: May 30, 2019

(54) Search User Interface

(71) Applicants: Matthew Creedican, Arlington, WA (US); Sohan V. Mikkilineni, Boston, MA (US)

(72) Inventors: Matthew Creedican, Arlington, WA (US); Sohan V. Mikkilineni, Boston, MA (US)

(21) Appl. No.: 15/824,872

(22) Filed: Nov. 28, 2017

(51) Int. Cl. G06F 17/30

(52) U.S. Cl. CPC G06F 17/30648; G06F 17/30994; G06F 17/30991

(57) ABSTRACT

A search user interface may enable a user to interact with a search engine by indicating relevance values for search engine results. Various means may be used to indicate a relevance value of a search engine result tailored to target desired content. The user may be enabled to refine search engine results based on relevance value designations over multiple iterations.

### FIELD

This disclosure relates generally to a search user interface.

### BACKGROUND

When computer users conduct a search of a database or on the internet, they may use computer features to interact with a search engine. A person user may enter terms into a search box that calls out functions in a search engine, and a search engine output may display search results. Because users are generally drawn to search results near the top of the page, often users may not be satisfied with the search results because results may not be relevant to the user's primary question, and sifting through all the results may be fruitless. It may be burdensome and time-consuming for users to repeatedly modify their search query because of the irrelevancy of the results retrieved. Thus, obtaining answers to user's primary question may involve reading through numerous unwanted search results.

### SUMMARY

The instant application discloses, among other things, a search user interface.

A search user interface may handle interaction between a user and a computer system. The purpose of a search user interface interaction may be to control the computer system from the user end to refine search engine results.

A user may be enabled to enter a search query value, for example, a string, to retrieve results. After a query is run, a search engine may output a display of retrieved search results. A search user interface may enable the user to select or reject certain search results, depending on their relevance to the desired query. The user's selection and designation of results via the search user interface may be captured as input for search engine processes to minimize undesired outputs in a future search result output.

A user may employ a search user interface to refine search engine result content to target desired content. For example, a user may drag and drop search results into one of two buckets; one for good results and one for undesired results. This may allow the search engine to refine results.

Other ways of notifying the search engine of the relevancy of results may include a points system, a color scheme, an emotional reaction icon, or a checkbox. One having skill in the art will recognize that other forms of indicating relevance may be used.

A search user interface may be tailored to operate on various computer systems used in various contexts for different types of users. For example, a search user interface suited for a library may provide a library database search engine for its patrons with limited sets of functions, whereas as a search user interface tailored for a world wide web search engine may enable users access to a wider set of functions.

A user's search experience may be enriched by a search user interface by enabling the user to customize, and re-customize search engine outputs thereby improving the relevancy of results. It would be apparent to one having ordinary skill in the art that multiple types of user interface techniques may be implemented to indicate the relevance value of a search result.

### BRIEF DESCRIPTION OF THE DRAWINGS

FIG. 1 illustrates a search user interface according to one embodiment.

FIG. 2 illustrates a search user interface according to one embodiment.

FIG. 3 illustrates a search user interface according to one embodiment.

FIG. 4 is a flow diagram illustrating a search user interface process, according to one embodiment.

FIG. 5 is a block diagram illustrating an example of a system capable of supporting Search User Interface, according to one embodiment.

FIG. 6 illustrates a component diagram of a computing device, according to one embodiment.

### DETAILED DESCRIPTION

A more particular description of certain embodiments of Information Overlay may be had by references to the embodiments described below, and those shown in the drawings that form a part of this specification, in which like numerals represent like objects.

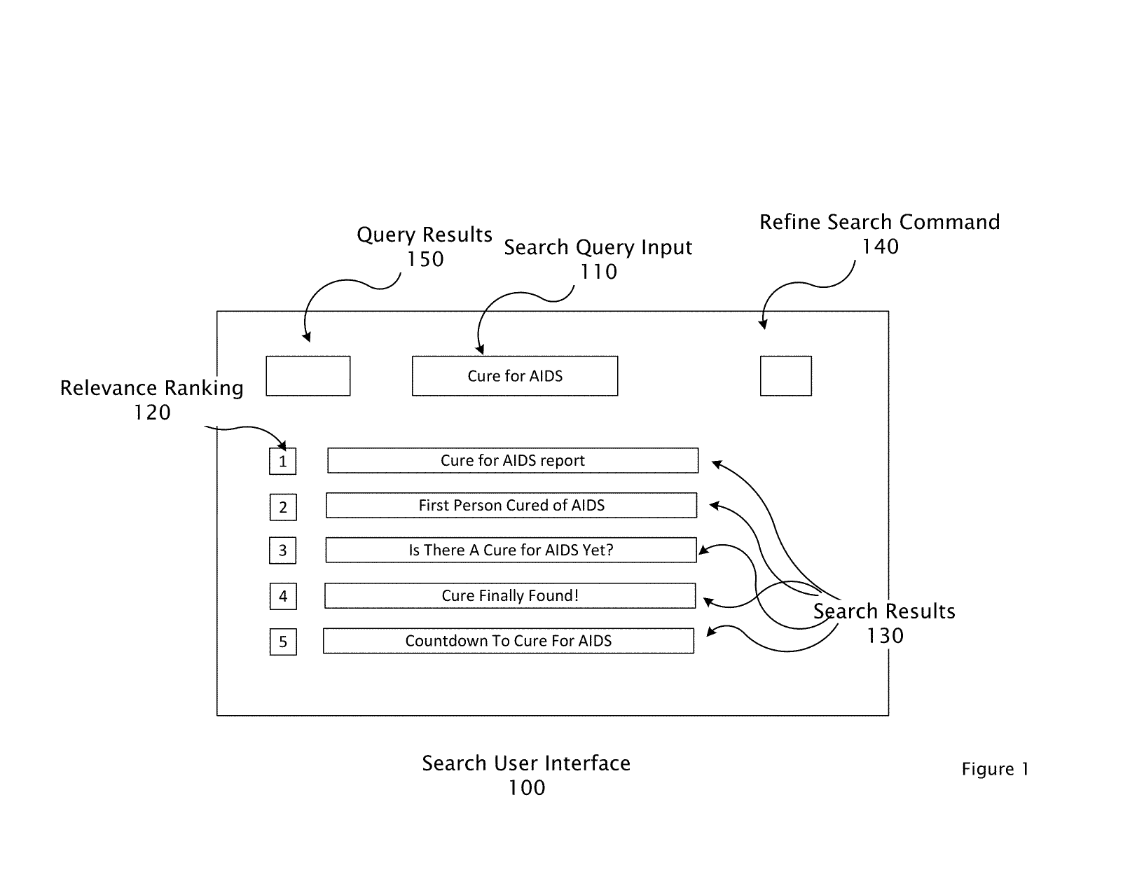

FIG. 1 illustrates a Search User Interface 100 according to one embodiment. Search User Interface 100 may consist of a Search Query Input 110, Relevance Ranking 120, and at least one instance of Search Results 130, and a Refine Search Command 140 which may enable a user to store some Search Results 130 she selected with Relevance Ranking 120 and process those selections as an extension of Search Query Input 110.

Search Query Input 110 may receive as input any combination of symbols including, string characters, mathematical operators, dates, or other symbols. Search Results 130 may be retrieved by submitting Search Query Input 110 to a search engine. In this illustration of this embodiment, there are five Search Results 130.

Relevance Ranking 120 may be a self-explanatory means of operating a computer system to enable a user to target desired content.

Here, Relevance Ranking 120 may be a checkbox associated with an instance of Search Results 130 which may be used to select or unselect that particular result, indicating the relevance value of the result. Search User Interface 100 may enable the user to modify selection and designation of Search Results 130. For example, a checkbox may be unchecked. For illustration purposes, a user may have a primary question which relates to finding scientific discovery which led to finding cure for AIDS may enter “cure for AIDS” as Search Query Input 110, and some of the retrieved Search Results 130 may relate to newspaper headlines, while others may relate to the “First Person Cured of AIDS.”

User's primary question relates to the scientific basis behind the cure, so she may rank instances of Search Results 130 as relevant by using Relevance Ranking 120 on each result. For example, checking a box or not checking a box to indicate relevancy or irrelevancy. Here, Search Results 1, 2, and 4 may be checked to indicate they are relevant to user's primary question. Other examples of a Relevance Ranking 120 means are a color scheme or points system, or a drag and drop feature which may enable a user to drag a particular Search Results 130 to a location on the interface. It would be apparent to one having ordinary skill in the art that various interfaces may serve the purpose of enabling the user to indicate relevance, and relevance values may be calculated in different ways.

The user's selection and designation of results via Relevance Ranking 120 may be captured as input for Refine Search Command 140 for search engine processes which may decrease undesired outputs in future output of Search Results 130. Search User Interface 100 may enable user access to various results stored as input from other searches. It would be apparent to one having ordinary skill in the art that controls may be used for the user interface to save search results.

Search Query Input 110 may be refined using Query Results 150, which may enable a user to create a new query to process relevant Search Results 130. Query Results 150 may generate new Search Results 130 while simultaneously maintaining the previous Search Results 130 that were given a positive Relevance Ranking 120 value. Query Results 150 may receive as input any combination of symbols including, string characters, mathematical operators, dates, or other symbols.

A user may employ features of Search User Interface 100 for multiple iterations to refine search engine result content. Search User Interface 100 may enable the user to save or send Search Results 130 via email, for example. It would be apparent to one having ordinary skill in the art that there are various techniques for sending and saving Search Results 130.

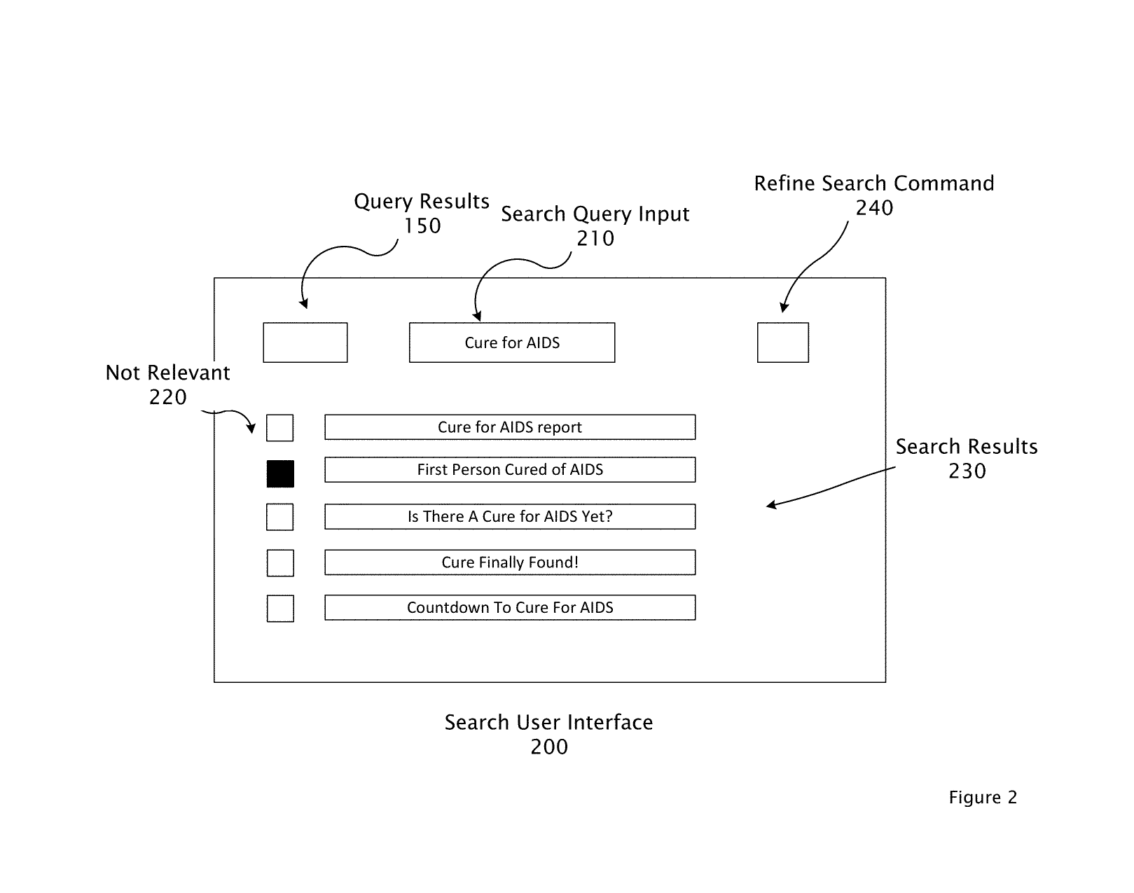

FIG. 2 illustrates a Search User Interface 200 according to another embodiment. Search Query Input 210 may allow a user to enter a search query. A user may designate relevancy of Search Results 230. These designations may be captured as input for Refine Search Command 240, which may function to minimize undesired outputs in future Search Results 230.

A user may designate instances of Search Results 230 as relevant or irrelevant in order to refine search engine result content, using self-explanatory means of operating a computer system to target desired content, such as may be a color scheme, emotional reaction icon, or a drag and drop computer operation feature, for example. A drag and drop operation feature may, for example, enable a user to drag a particular search result to a location on the interface, such as Not Relevant 220, to indicate result relevance value to primary search question. Here, the user may indicate that “First Person Cured of AIDS” is not relevant to a primary question by dragging that result to a Not Relevant 220 box. Search User Interface 200 may enable the user to modify selection and designation of results. For example, the user may be enabled to retrieve results from Not Relevant 220 and make them part of Search Results 230 list again.

The user may be enabled to interact with the computer system via Search User Interface 200 for multiple iterations to capture user relevancy indications and refine search engine result content. One having ordinary skill in the art would appreciate that there are various techniques for flagging Search Results 230 as relevant or irrelevant.

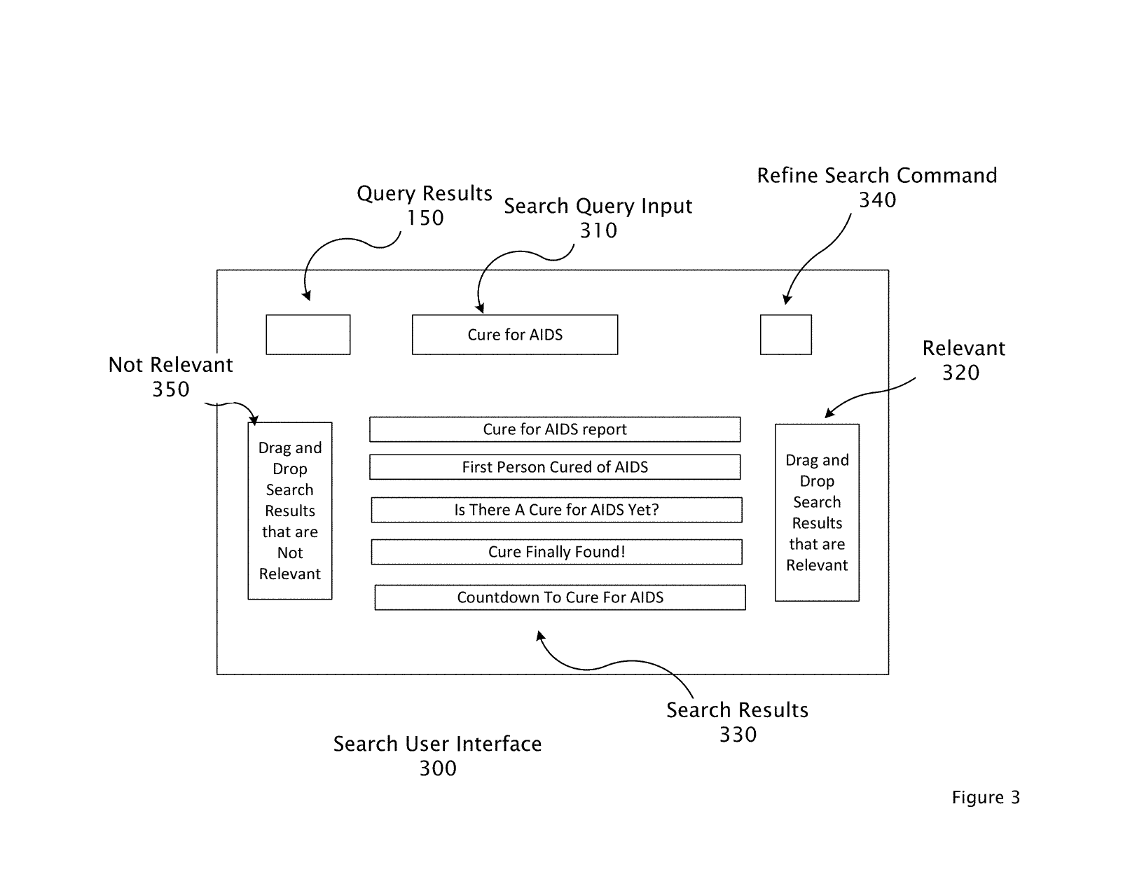

FIG. 3 illustrates a Search User Interface 300 according to another embodiment. Search Query Input 310 may allow a user to enter a search query. A user may designate relevancy of Search Results 330. These designations may be captured as input for Refine Search Command 340, which may function to minimize undesired outputs in future Search Results 330.

A user may designate instances of Search Results 330 as relevant or not relevant in order to refine search engine result content, using self-explanatory means of operating a computer system to target desired content, such as may be a color scheme, emotional reaction icon, or a drag and drop computer operation feature, for example. A drag and drop operation feature may, for example, enable a user to drag a particular search result to a location on the interface, such as Relevant 320 or Not Relevant 350, to indicate result relevance value to primary search question. Here, the user may indicate that “First Person Cured of AIDS” is not relevant to a primary question by dragging that result to a Not Relevant 350 box. Search User Interface 300 may enable the user to modify selection and designation of results. For example, the user may be enabled to retrieve results from Not Relevant 350 and make them part of Search Results 330 list again.

The user may be enabled to interact with the computer system via Search User Interface 300 for multiple iterations to capture user relevancy indications and refine search engine result content. One having ordinary skill in the art would appreciate that there are various techniques for flagging Search Results 330 as relevant or irrelevant.

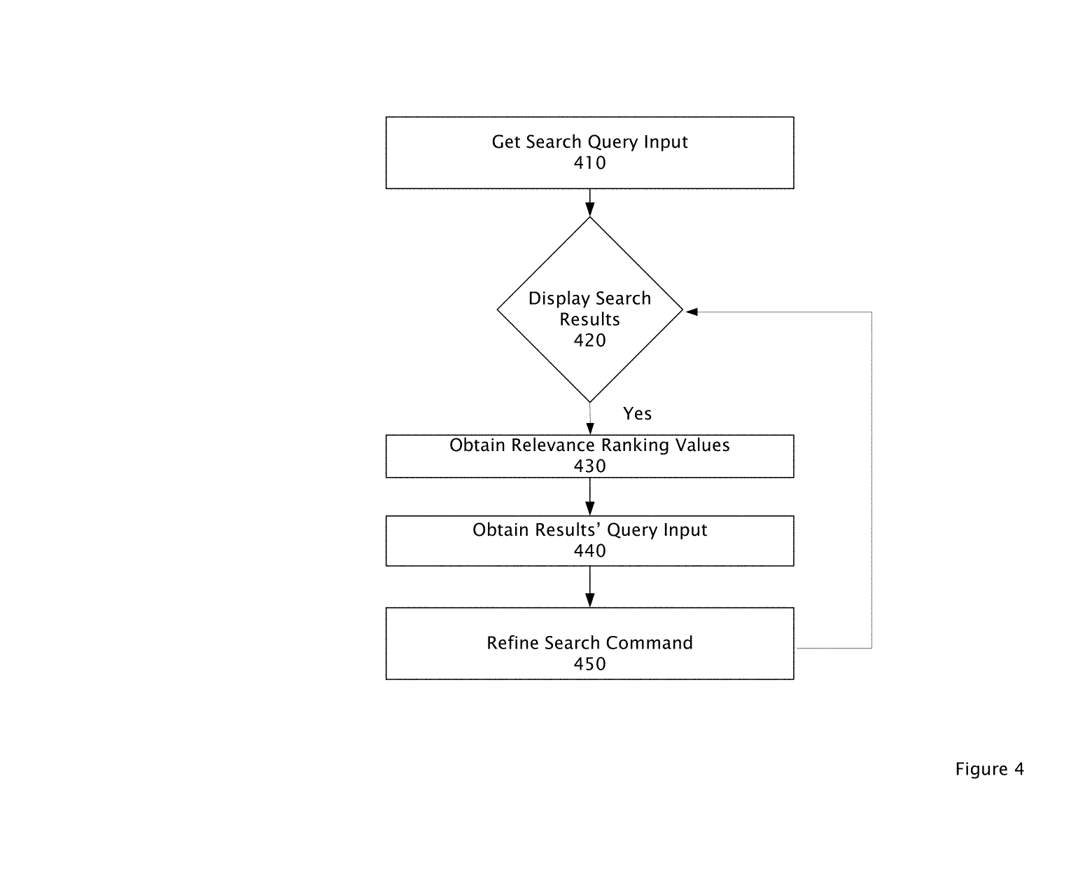

FIG. 4 illustrates a flowchart to show a Search User Interface embodiment as it processes interactions between person user and computer system. Get Search Query Input 410 may enable the user to enter values, for example, strings or images, to create primary search question to search by on search engine. Here, for example, the user may enter “Cure for AIDS” to search for scientific basis behind a cure for AIDS. After query input is captured, search engine searches database(s) and retrieves information that it matches to Get Search Query Input 410 values.

At Display Search Results 420 the computer system may output a list of information found in one or more database(s). If the user is satisfied with information retrieved from a search, the user may store or otherwise share Display Search Results 420. If the user is not satisfied with the information in Display Search Results 420, then the user may refine the search. From here, the user may provide input and computer system may use Obtain Relevance Ranking Values 430 indicating the relevance of each instance of information retrieved. The computer system may capture these indications as input to execute another search. At Obtain Results' Query Input 440, the user may be enabled to modify, append, or create a new query to search within contents of retrieved information, as in Display Search Results 420. At Obtain Results' Query Input 440 the user may enter values, such as strings or images, for the computer system to capture and process in order to run a search. At Refine Search Command 450 the computer system may sort out certain search results and base search on captured indications and search queries to find matching information.

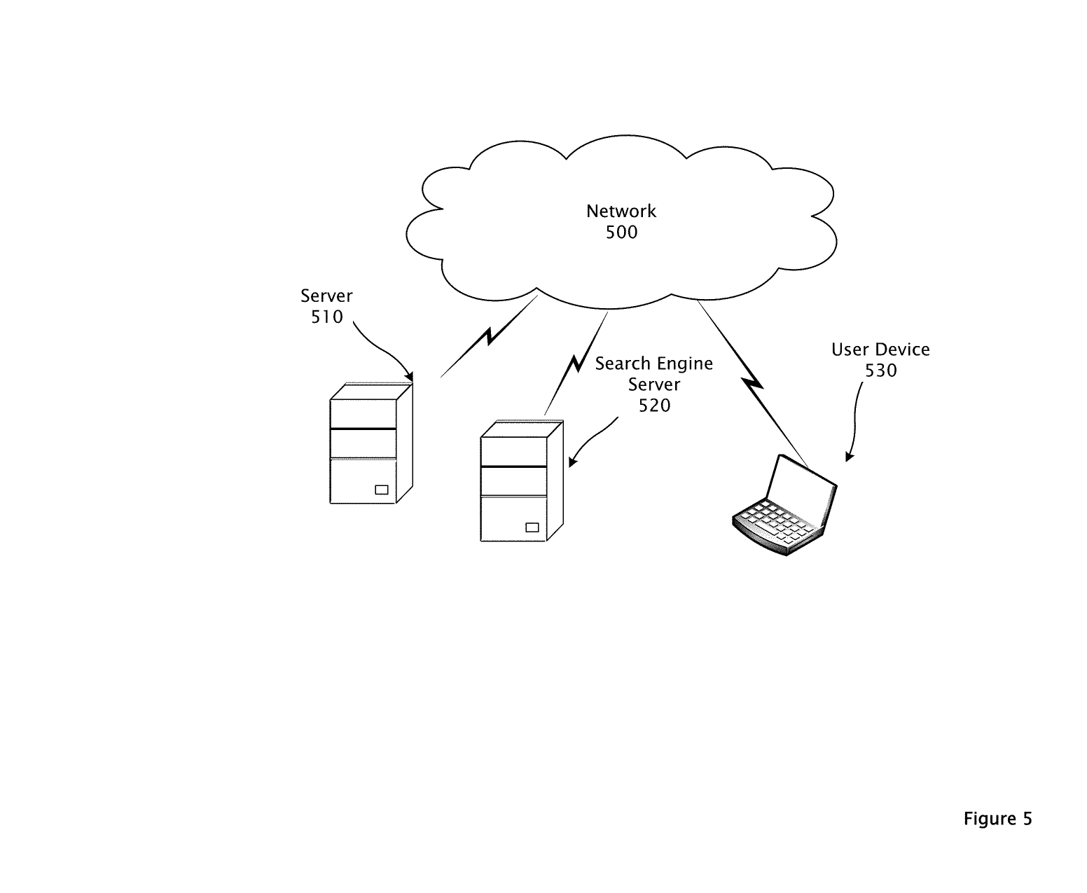

FIG. 5 is a block diagram illustrating an example of a system capable of supporting Search User Interface, according to one embodiment. One or more User Device 530 may be coupled to each other, a server, or to other devices via Network 500. User Device 530 may include a smartphone, tablet, laptop computer, smartwatch, or intelligent eyewear, for example.

Network 500 may include Wi-Fi, cellular data access methods, such as 3G or 4GLTE, Bluetooth, NFC, the internet, local area networks, wide area networks, or any combination of these or other means of providing data transfer capabilities. In one embodiment, Network 500 may comprise Ethernet connectivity. In another embodiment, Network 500 may comprise fiber optic connections.

Server 510 may include one or more computers, and may serve several roles. Server 510 may be conventionally constructed, or may be of a special purpose design for processing data. One skilled in the art will recognize that Server 510 may be of many different designs and may have different capabilities. Server 510 may host applications, data, or other information supporting Search User Interface.

User Device 530 may be used to access information or programs on Server 510. User Device 530 may also be coupled directly via Ethernet, Wi-Fi, Bluetooth, NFC, or other technologies.

User Device 530, Server 510, and Search Engine Server 520 may communicate via Network 500. A user may be enabled to use Relevance Ranking 120 indicators on User Device 530. Search Query Input 110, Query Results 150, and Refine Search Command 140 may capture input from the user and submit to Server 510, which may submit search terms to Search Engine Server 520. Search Results 130 may list filtered search results and may be displayed to User Device 530.

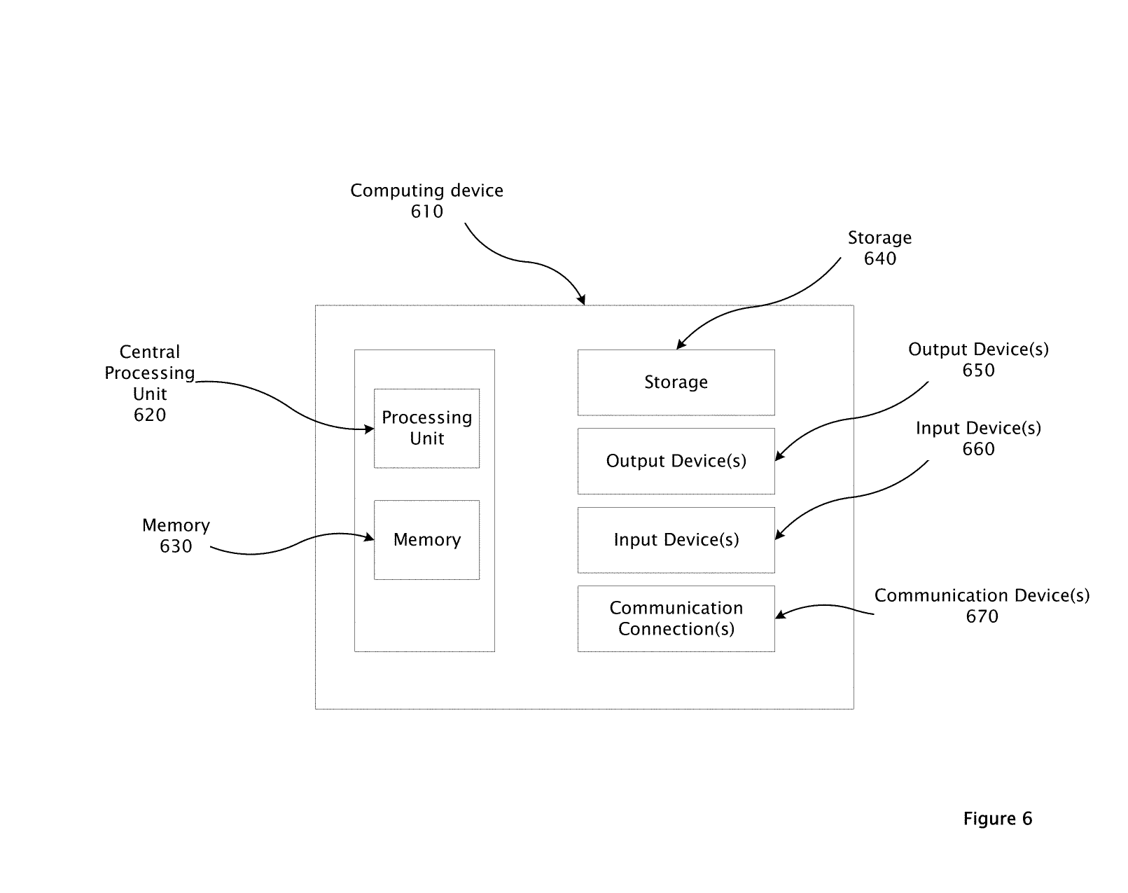

FIG. 6 illustrates a component diagram of a computing device, according to one embodiment. Computing Device 610 can be utilized to implement one or more computing devices, computer processes, or software modules described herein, including, for example, but not limited to a mobile device or a server. In one example, Computing Device 610 can be used to process calculations, execute instructions, and receive and transmit digital signals. In another example, Computing Device 610 can be utilized to process calculations, execute instructions, receive and transmit digital signals, receive and transmit search queries and hypertext, and compile computer code suitable for a mobile device. Computing Device 610 can be any general or special purpose computer now known or to become known capable of performing the steps and/or performing the functions described herein, either in software, hardware, firmware, or a combination thereof.

In its most basic configuration, Computing Device 610 typically includes at least one Central Processing Unit (CPU) 620 and Memory 630. Depending on the exact configuration and type of Computing Device 610, Memory 630 may be volatile (such as RAM), non-volatile (such as ROM, flash memory, etc.) or some combination of the two. Computing Device 610 may also have additional features/functionality. For example, Computing Device 610 may include multiple CPUs. The described methods may be executed in any manner by any processing unit in Computing Device 610. For example, the described process may be executed by both multiple CPUs in parallel.

Computing Device 610 may also include additional storage (removable and/or non-removable) including, but not limited to, magnetic or optical disks or tape. Computer readable storage media include volatile and nonvolatile, removable and non-removable media implemented in any method or technology for storage of information such as computer-readable instructions, data structures, program modules or other data. Memory 630 and Storage 640 are all examples of computer-readable storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by Computing Device 610. Any such computer-readable storage media may be part of Computing Device 610. Computer readable storage media do not include transient signals.

Computing Device 610 may also contain Communication Device(s) 670 that allows the device to communicate with other devices. Communication Device(s) 670 is an example of communication media. Communication media typically embody computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media. The term computer-readable media as used herein includes both computer-readable storage media and communication media. The described methods may be encoded in any computer-readable media in any form, such as data, computer-executable instructions, and the like.

Computing Device 610 may also have Input Device(s) 660 such as a keyboard, mouse, pen, voice input device, touch input device, etc. Output Device(s) 650 such as a display, speakers, printer, etc. may also be included. All these devices are well known in the art and need not be discussed at length.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a digital signal processor (DSP), programmable logic array, or the like.

While the detailed description above has been expressed in terms of specific examples, those skilled in the art will appreciate that many other configurations could be used. Accordingly, it will be appreciated that various equivalent modifications of the above-described embodiments may be made without departing from the spirit and scope of the invention.

Additionally, the illustrated operations in the description show certain events occurring in a certain order. In alternative embodiments, certain operations may be performed in a different order, modified or removed. Moreover, steps may be added to the above-described logic and still conform to the described embodiments. Further, operations described herein may occur sequentially, or certain operations may be processed in parallel. Yet further, operations may be performed by a single processing unit or by distributed processing units.

The foregoing description of various embodiments of the invention has been presented for the purposes of illustration and description. It is not intended to be exhaustive or to limit the invention to the precise form disclosed. It is intended that the scope of the invention be limited not by this detailed description, but rather by the claims appended hereto. The above specification, examples, and data provide a complete description of the manufacture and use of the invention. Since many embodiments of the invention can be made without departing from the spirit and scope of the invention, the invention resides in the claims hereinafter appended.

1. A method, comprising:
receiving a first search request comprising a first search term;
returning a plurality of results from a search engine for the search term;
providing a means for a user to indicate a relevance rating for each of the plurality of the returned results;
receiving a second search request comprising the first search term; and
returning a result list from a search engine for the search term, with the result list refined based on the relevance rating.

2. The method of claim 1 wherein the means for the user to indicate the relevance rating comprises a checkbox for each result.

3. The method of claim 1 wherein the means for the user to indicate the relevance rating comprises allowing the user to drag a result into a location on a user interface.

4. The method of claim 1 wherein the means for the user to indicate the relevance rating comprises a for each result.

5. The method of claim 1 wherein the means for the user to indicate the relevance rating comprises allowing the user to select an emotional reaction icon.
